(19) United States
(12) Patent Application Publication
(10) Pub. No.: US 2013/0216913 A1
(43) Pub. Date: Aug. 22, 2013

(54) NON-AQUEOUS ELECTROLYTE SECONDARY BATTERY

(71) Applicant: SANYO ELECTRIC CO., LTD., (US)

(72) Inventors: Shingo Tode, Kasai City (JP); Fumiharu Niina, Kobe City (JP); Toshikazu Yoshida, Kasai City (JP); Yoshinori Kida, Kobe City (JP); Toyoki Fujihara, Kanzaki County (JP); Toshiyuki Nohma, Kobe City (JP)

(73) Assignee: SANYO ELECTRIC CO., LTD., Osaka (JP)

(21) Appl. No.: 13/764,806

(22) Filed: Feb. 12, 2013

(30) Foreign Application Priority Data
Feb. 20, 2012 (JP) 2012-033649

(51) Int. Cl. H01M 4/131

(52) U.S. Cl. CPC H01M 4/131
USPC 429/221; 429/223

(57) ABSTRACT

A nonaqueous electrolyte secondary battery comprises: a positive electrode containing a lithium-transition metal complex oxide having a layered structure as a positive electrode active material; a negative electrode containing a negative electrode active material capable of occluding and releasing lithium ions; and a nonaqueous electrolyte, wherein the lithium-transition metal complex oxide is represented by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn), contains Zr, and has an average crystallite size of 1300 Å or less as calculated using the Halder-Wagner method from an integral breadth calculated using the Pawley method. It is thereby possible to suppress a reduction in battery capacity and/or output characteristics caused by high-rate charge/discharge cycling.

### TECHNICAL FIELD

The present invention relates to a nonaqueous electrolyte secondary battery comprising: a positive electrode containing a lithium-transition metal complex oxide having a layered structure as a positive electrode active material; a negative electrode containing a negative electrode active material capable of occluding and releasing lithium ions; and a nonaqueous electrolyte.

### BACKGROUND ART

Specifications required in a nonaqueous electrolyte secondary battery used in mobile electronic devices, electric vehicles (EV), hybrid electric vehicles (HEV), and the like are becoming more rigorous year by year in accompaniment with the rapid increase is such devices and vehicles. There is a particular need for a nonaqueous electrolyte secondary battery having stable performance and excellent cycling characteristics at high capacity and high output.

Electronic devices and vehicles, or the like in which a nonaqueous electrolyte secondary battery is mounted may be used under various temperature conditions. Therefore, there is a need of a nonaqueous electrolyte secondary battery to maintain sufficient characteristics even when charging and discharging are carried out in various temperature conditions.

A lithium-transition metal complex oxide having a layered structure represented by LiₓMO₂ (where M is at least one of Co, Ni, and Mn) and that is capable of reversibly occluding and releasing lithium ions, i.e., LiCoO₂, LiNiO₂, LiNi_{y}Co_{1-y}O₂ (y=0.01 to 0.99), LiMnO₂, LiNiₓCo_{y}Mn_{z}O₂ (x+y+z=1), or LiMn₂O₄, LiFePO₄, or the like, are used alone or as mixed plurality as the positive electrode active material in such a nonaqueous electrolyte secondary battery.

In recent years, attention is being given to lithium-transition metal complex oxides that have a layered structure primarily composed of Ni, which has high capacity per unit of mass. For example, PCT International Publication No. WO2009/099158 discloses a method for manufacturing a positive electrode active material for a lithium ion secondary battery which has high volume capacity density, packing density, and stability, and which has excellent charge/discharge cycling durability; and discloses a lithium-transition metal complex oxide primarily composed of Ni as the positive electrode active material.

In the case that a nonaqueous electrolyte secondary battery is charged and discharged at a high rate, it is possible that an overvoltage will be imposed and that electrolyte decomposition or the like will occur. Therefore, there is a need to ensure that an onboard nonaqueous electrolyte secondary battery or the like, which undergoes charging and discharging at a high rate, does not experience a reduction in battery characteristics when charging and discharging is carried out at a high rate.

A nonaqueous electrolyte secondary battery that uses as the positive electrode active material a lithium-transition metal complex oxide having a layered structure primarily composed of Ni as represented by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn) can be used as a battery with high energy density, but when charging and discharging at a high rate is repeated, a problem occurs in that the battery capacity is reduced and/or the output characteristics are reduced.

As a result of detailed research, the present inventors believe that the above-stated problem occurs because a lithium-transition metal complex oxide having a layered structure primarily composed of Ni as represented by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn) undergoes considerable change in the volume of crystals due to charging and discharging, the electroconductive path in the lithium-transition metal complex oxide is short-circuited due to repeated charging and discharging, electron conductivity is reduced, and the absolute amount of lithium-transition metal complex oxide that can contribute to charging and discharging is reduced.

As a result of disassembling a nonaqueous electrolyte secondary battery which had actually undergone repeated high-rate charging and discharging and analyzing the lithium-transition metal complex oxide, cracks were observed in the primary particles and between primary particles that form the secondary particles of the lithium-transition metal complex oxide. In view of this finding, it is believed that electroconductive paths were short-circuited and electron conductivity was reduced due to repeated high-rate charging and discharging, which produced cracks in the primary particles and between primary particles of the lithium-transition metal complex oxide; and battery capacity and output characteristics were reduced due to a decrease in the absolute amount of lithium-transition metal complex oxide capable of contributing to charging and discharging.

### SUMMARY

An object of the present invention is to solve the above-described problem, and to provide a nonaqueous electrolyte secondary battery in which a reduction in battery capacity and/or output characteristics caused by high-rate charge/discharge cycling is suppressed.

The nonaqueous electrolyte secondary battery of the present invention comprises: a positive electrode containing a lithium-transition metal complex oxide having a layered structure as a positive electrode active material; a negative electrode containing a negative electrode active material capable of occluding and releasing lithium ions; and a nonaqueous electrolyte, the nonaqueous electrolyte secondary battery characterized in that the lithium-transition metal complex oxide is represented by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn), contains Zr, and has an average crystallite size of 1300 Å or less as calculated using the Halder-Wagner method from an integral breadth calculated using the Pawley method.

In the present invention, a nonaqueous electrolyte secondary battery having high energy density is obtained by using as the positive electrode active material a lithium-transition metal complex oxide represented by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn).

In the present invention, the average crystallite size of the lithium-transition metal complex oxide is set to 1300 Å or less as calculated using the Halder-Wagner method from an integral breadth calculated using the Pawley method, whereby severance of the electroconductive path due to a change in volume of the lithium-transition metal complex oxide can be suppressed even when high-rate charge/discharge cycling is carried out. The average crystallite size L of the lithium-transition metal complex oxide in the present invention is calculated in the following manner.

### <Method for Calculating the Average Crystallite Size L>

1) Calculate the integral breadth β₁ from the integral intensity and the peak height using a segmented quasi-Voigt function in the Pawley method using 10 peaks of the Miller indices (100), (110), (111), (200), (210), (211), (220), (221), (310), and (311) from the X-ray diffraction pattern of a standard reference material for X-ray diffraction (National Institute of Standards and Technology (NIST) Standard Reference Materials (SRM) 660b (LaB₆))

2) Obtain the best fit using a segmented quasi-Voigt function in the Pawley method using 10 peaks of the Miller indices (003), (101), (006), (012), (104), (015), (107), (018), (110), and (113) from the X-ray diffraction pattern of the measurement sample (lithium-transition metal complex oxide), and calculate the integral breadth β₂ from the integral intensity and the peak height.

3) Calculate the integral breadth β derived from the measurement sample on the basis of formula (a) from the above results.

Integral breadth β derived from the measurement sample=β₂−β₁ (a)

4) Plot β²/tan²θ with respect to β/(tan θ sin θ) using the Halder-Wagner method, and calculate the average crystallite size L derived from the measurement sample from the slope of the approximate line.

The average crystallite size in all directions in the crystal can be obtained by calculating the crystallite size of the lithium-transition metal complex oxide using the above-described method. Therefore, it is possible to estimate the amount of severance of the electroconductive paths caused by the change in the volume of the lithium-transition metal complex oxide that accompanies charging and discharging. The crystallite size is generally calculated using the Scherrer formula. However, the crystallite size calculated by the Scherrer formula is obtained from the half-value width of a specific peak in an X-ray diffraction pattern, and that which is obtained is the size in a specific direction in the crystal. Therefore, it is difficult to estimate the amount of severance of electroconductive paths caused by a change in the volume of the lithium-transition metal complex oxide that accompanies charging and discharging.

In the present invention, the average crystallite size of the lithium-transition metal complex oxide is preferably 450 Å or more, and more preferably 550 Å or more. When the average crystallite size is 450 Å or more, crystal growth is sufficient, there is little possibility that impurities will be included, and a nonaqueous electrolyte secondary battery having greater energy density and excellent output characteristics can be produced.

The average crystallite size of the lithium-transition metal complex oxide can be controlled by adjusting the baking time and temperature. For example, the average crystallite size tends to be smaller when the baking temperature is reduced, and the average crystallite size tends to be smaller when the baking time is reduced. The average crystallite size can be controlled using a method for admixing an additive for accelerating or inhibiting crystal growth, and a method for adjusting the amount of the compound to be mixed as the Li source during baking. The average crystallite size can also be controlled by controlling the particle diameter and the particle size distribution of the precursor of the lithium-transition metal complex oxide, by adjusting the Ni, Mn, Co composition, or by using other methods. For example, the average crystallite size tends to increase when the amount of the compound to be mixed as the Li source during baking is increased.

In the present invention, high-rate charge/discharge cycling characteristics are improved by including Zr in the lithium-transition metal complex oxide. This is thought to be due to the fact that the oxidized state of the lithium-transition metal complex oxide is changed by the inclusion of Zr in the lithium-transition metal complex oxide, and dissolution or the like of the electrolyte due to overvoltage can be inhibited. Zr is preferably present as an oxide in the grain boundary or particle surface of the lithium-transition metal complex oxide, and a portion may be taken into transition metal sites of the lithium-transition metal complex oxide. The Zr content of the lithium-transition metal complex oxide is preferably 0.1 to 3.0 mol % with respect to the total amount of Ni, Co, and Mn in the lithium-transition metal complex oxide. In particular, the Zr content present in the grain boundary or particle surface of the lithium-transition metal complex oxide is preferably 0.1 to 3.0 mol % with respect to the total amount of Ni, Co, and Mn in the lithium-transition metal complex oxide.

Zr is preferably admixed with the lithium-transition metal complex oxide using a method in which a Zr compound is mixed and baked with the lithium-transition metal complex oxide precursor when the lithium-transition metal complex oxide is baked. Zr is more readily present near the surface of the lithium-transition metal complex oxide in this manner than by adding the Zr compound in the precursor production stage, and the dissolution the electrolyte can be more effectively suppressed.

In the present invention, the lithium-transition metal complex oxide is preferably represented by the general formula Li₁₊ₐNiₓCo_{y}Mn_{z}M_{b}O₂ (where 0≦a≦0.15, 0≦b≦0.05, 0.4≦x≦0.8, 0<y≦0.35, 0<z≦0.30, x+y+z+b=1, and M is one or more elements selected from other than Li, Ni, Co, and Mn).

The crystal structure is stabilized by the presence of Co and Mn in the structure of the lithium-transition metal complex oxide, which is the positive electrode active material. Therefore, a nonaqueous electrolyte secondary battery with even better high-rate charge/discharge cycling characteristics can be obtained.

In the present invention, the element M is preferably one or more elements selected from the group consisting of Al, Sr, Y, Zr, Ta, Mg, Ti, Zn, B, Ca, Cr, Si, Ga, Sn, P, V, Sb, Nb, Mo, W, and Fe. Particularly preferred among these is one or more elements selected from the group consisting of Al, Zr, Mg, and Ti.

In the present invention, the lithium-transition metal complex oxide is preferably an aggregation of primary particles that form secondary particles.

It is thought that in the case that the lithium-transition metal complex oxide, which is the positive electrode active material, is composed of only primary particles, the electroconductive agent is readily present between the particles, and severance of the electroconductive path due to volume change in the lithium-transition metal complex oxide due to charging and discharging is less likely to occur. In contrast, a positive electrode active material composed of an aggregation of primary particles that form secondary particles is less likely to have the electroconductive agent present between the primary particles, and severance of the electroconductive path due to volume change in the lithium-transition metal complex oxide due to charging and discharging is more likely to occur. Therefore, the present invention is particularly effective when a lithium-transition metal complex oxide composed of an aggregation of primary particles that form secondary particles is used.

In the present invention, the positive electrode has a positive electrode active material layer containing the lithium-transition metal complex oxide, which is the positive electrode active material, and a binder formed on the surface of a positive electrode substrate, the positive electrode active material layer contains a carbon material having a lower bulk density than the lithium-transition metal complex oxide, and the carbon material is contained in an amount of 3 mass % or more with respect to the total amount of the positive electrode active material.

The carbon material having a lower bulk density than the lithium-transition metal complex oxide, which is the positive electrode active material, not only serves as an electroconductive agent, but also serves as a buffer material and is capable of inhibiting the occurrence of cracks in the primary particles and between the primary particles of the lithium-transition metal complex oxide, which is the positive electrode active material. The bulk density of the carbon material is preferably 0.01 to 0.50 g/cc. In this range, a nonaqueous electrolyte secondary battery having high volume energy density can be obtained without a reduction in the packing density of the positive electrode active material.

In the present embodiment, the packing density of the positive electrode active material layer is preferably 2.0 to 3.5 g/cc, and even more preferably 2.0 to 3.0 g/cc.

The packing density of the positive electrode active material is set to be 3.5 g/cc or less, thereby making it possible to inhibit severance of the electroconductive path between the primary particles of the lithium-transition metal complex oxide and between the secondary particles and the electroconductive agent due to the effect of change in the volume of the lithium-transition metal complex oxide that accompanies charging and discharging. Also, setting the packing density of the positive electrode active material to 2.0 g/cc or more makes it possible to obtain a nonaqueous electrolyte secondary battery having a high volume energy density.

In the present invention, a carbon material is preferably used as the negative electrode active material, and the use of graphite is particularly preferred. The balance in the output regeneration characteristics can thereby be maintained in a wide range of charging and discharging depth in combination with a lithium-transition metal complex oxide used as the positive electrode active material in the present invention.

In the present invention, the packing density of the negative electrode active material is preferably 1.0 to 1.5 g/cc. Setting the packing density of the negative electrode active material to be 1.5 g/cc or less ensures that gaps can be formed between the negative electrode active material particles, makes it possible to alleviate changes in volume of the electrode plate, which undergoes expansion and contraction due to charging and discharging, and makes it possible to alleviate output reduction due to loosening of the electrode assembly. Also, setting the packing density of the negative electrode active material to be 1.0 g/cc or more makes it possible to obtain a nonaqueous electrolyte secondary battery having a high volume energy density.

In the present invention, it is possible to use carbonates, lactones, ethers, esters, or the like commonly used in nonaqueous electrolyte secondary batteries, as the nonaqueous solution (organic solvent) constituting the nonaqueous electrolyte. It is also possible to use a mixture of two or more of these solvents. Among these, carbonates, lactones, ethers, ketones, esters, or the like are preferred, and the use of carbonates is even more advantageous.

Examples that can be used include ethylene carbonate, propylene carbonate, butylene carbonate, and other cyclic carbonates; dimethyl carbonate, ethylmethyl carbonate, diethyl carbonate, and other chain carbonates. Particularly preferred is the use of a mixed solvent of a cyclic carbonate and a chain carbonate. It is also possible to add vinylene carbonate (VC) or another unsaturated cyclic carbonate ester to the nonaqueous electrolyte.

In the present invention, a lithium salt commonly used as a solute in a nonaqueous electrolyte secondary battery may be used as the solute constituting the nonaqueous electrolyte. Examples of such a lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, LiP(C₂O₄)F₄, and the like, and mixtures thereof. Preferably used among these is LiPF₆.

In the present invention, the separator may be a porous separator made of polypropylene (PP), polyethylene (PE), polypropylene (PP) and polyethylene (PE) in a tri-layer structure (PP/PE/PP or PE/PP/PE), or another polyolefin.

The onboard nonaqueous electrolyte secondary battery used in hybrid vehicles, battery-powered electric vehicles, and the like preferably have an output density of 2000 W/L or more at 3.0 Vcut at a 50% state of charge (SOC). It is also preferred that the internal resistance (impedance/resistance at 1 kHz) be 20 mΩ or less at room temperature.

An output density of 2000 W/L or more can be advantageously used in an electric vehicle (EV), a hybrid electric vehicle (HEV), or the like which require high output. Also, an internal resistance (impedance/resistance at 1 kHz) of 20 mΩ or less at room temperature makes it possible to inhibit an increase in battery temperature during high-rate charging and discharging. Also, the effect of overcharging can be reduced and dissolution of the electrolyte or other side effects can be inhibited.

### BRIEF DESCRIPTION OF THE DRAWINGS

FIG. 1 is a schematic cross-sectional view showing a cylindrical nonaqueous electrolyte secondary battery according to the examples and comparative examples of the present invention;

FIG. 2 is a schematic cross-sectional view showing a quadrangular nonaqueous electrolyte secondary battery according to the examples and comparative examples of the present invention;

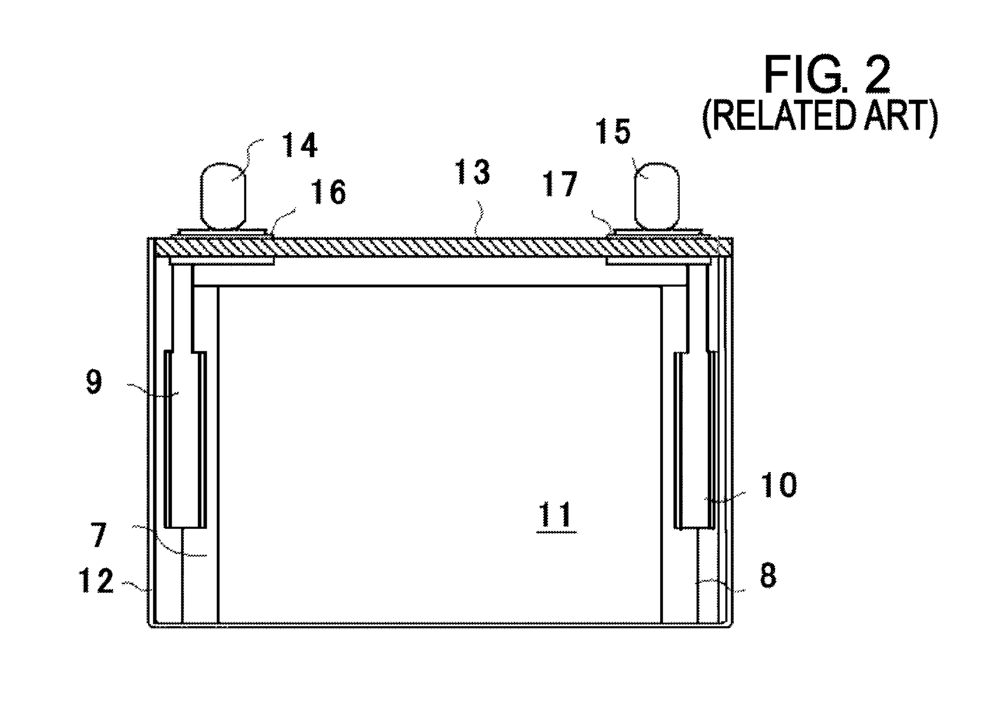

FIG. 3 is a graph showing the results of the first experiment, and is a graph showing the relationship between the average crystallite size and the capacity retention ratio;

FIG. 4 is a graph showing the results of the second experiment, and is a graph showing the relationship between the average crystallite size and the capacity retention ratio; and

FIG. 5 is a schematic cross-sectional view of the three-electrode test cell used in the third experiment.

### DETAILED DESCRIPTION

The present invention is described in detail below using examples and comparative examples. However, the examples described below are examples of a nonaqueous electrolyte secondary battery for embodying the technical concepts of the present invention, and the present invention is not intended to be limited to these examples. The present invention may be equally applied to various modifications that do not depart from the technical concepts shown in the claims.

### Experiment 1

### Example 1

### Production of a Positive Electrode Plate

Li₂CO₃, (Ni_{0.50}Co_{0.20}Mn_{0.30})₃O₄, and ZrO₂ were mixed together so that the molar ratio of Li, (Ni_{0.50}CO_{0.20}Mn_{0.30}), and Zr was 1.15:1:0.005. Next, this mixture was baked for 20 hours at 840° C. in an air atmosphere, and a lithium-transition metal complex oxide (Li_{1.15}Ni_{0.50}Co_{0.20}Mn_{0.30}O₂ in which Zr is present near the particle surface) containing 0.5 mol % of Zr with respect to the total amount of Ni, Co, and Mn was obtained and used as the positive electrode active material. The average crystallite size of the lithium-transition metal complex oxide was 1183 Å, and the bulk density was 2.10 g/cc. The positive electrode active material produced in the manner described above, carbon black as an electroconductive agent, and a solution of polyvinylidene fluoride (PVdF) as a binder dissolved in N-methyl-2-pyrrolidone (NMP) were kneaded together so that the mass ratio of positive electrode active material and carbon black and PVdF was 88:9:3 to produce a positive electrode slurry. The bulk density of the carbon black used in this case was 0.16 g/cc. The produced positive electrode slurry was coated on both surfaces of an aluminum alloy foil (thickness: 15 μm) as the positive electrode substrate, and then allowed to dry to remove the NMP used as the solvent during slurry production and form a positive electrode active material mixture layer. The positive electrode active material layer was thereafter calendered to a predetermined packing density (2.60 g/cc) using calendar rolls, and a positive electrode lead was attached to the exposed portion of the positive electrode substrate to thereby produce a positive electrode plate on which a positive electrode active material layer had been formed on both sides of a positive electrode collector assembly.

The average crystallite size of the positive electrode active material was obtained using the following method. The average crystallite sizes of the lithium-transition metal complex oxides in examples 1 to 5 and comparative examples 1 to 4 are all values obtained using the following method.

### <Method for Calculating the Average Crystallite Size L>

1) Calculate the integral breadth β₁ from the integral intensity and the peak height using a segmented quasi-Voigt function in the Pawley method using 10 peaks of the Miller indices (100), (110), (111), (200), (210), (211), (220), (221), (310), and (311) from the X-ray diffraction pattern of a standard reference material for X-ray diffraction (National Institute of Standards and Technology (NIST) Standard Reference Materials (SRM) 660b (LaB₆)).

2) Obtain the best fit using a segmented quasi-Voigt function in the Pawley method using 10 peaks of the Miller indices (003), (101), (006), (012), (104), (015), (107), (018), (110), and (113) from the X-ray diffraction pattern of the measurement sample (lithium-transition metal complex oxide), and calculate the integral breadth β₂ from the integral intensity and the peak height.

3) Calculate the integral breadth β derived from the measurement sample on the basis of formula (a) from the above results.

Integral breadth β derived from the measurement sample=β₂−β₁ (a)

4) Plot β²/tan²θ with respect to β/(tan θ sin θ) using the Halder-Wagner method, and calculate the average crystallite size L derived from the measurement sample from the slope of the approximate line.

The X-ray diffraction pattern was measured by packing the lithium-transition metal complex oxide into a sample holder, and using an X-ray diffraction device (RINT-TTR2 manufactured by Rigaku Corporation) using Cu-Kα rays, an X-ray tube voltage of 50 kV, and an X-ray tube electric current of 300 mA.

The 10 peaks of the X-ray diffraction pattern of the lithium-transition metal complex oxide used for calculating the average crystallite size are listed below.
A peak indexed by the Miller index (003) near 2θ=18.7°
A peak indexed by the Miller index (101) near 2θ=36.7°
A peak indexed by the Miller index (006) near 2θ=37.9°
A peak indexed by the Miller index (012) near 2θ=38.4°
A peak indexed by the Miller index (104) near 2θ=44.5°
A peak indexed by the Miller index (015) near 2θ=48.6°
A peak indexed by the Miller index (107) near 2θ=58.6°
A peak indexed by the Miller index (018) near 2θ=64.4°
A peak indexed by the Miller index (110) near 2θ=65.0°
A peak indexed by the Miller index (113) near 2θ=68.3°

### [Production of a Negative Electrode Plate]

A matrix of spheroidized natural graphite was impregnated and coated with a mixture of pitch and carbon black. In this case, the natural graphite, pitch, and carbon black were mixed so as to achieve a mass ratio of 100:5:5. Next, the mixture was baked at 900 to 1500° C., the baked product was pulverized, and a graphite surface-coated with an amorphous carbon was obtained and used as the negative electrode active material. The negative electrode active material obtained in the manner described above, carboxymethyl cellulose (CMC) as a viscosity improver, and styrene-butadiene rubber (SBR) as a viscosity improver were kneaded together with water to produce a negative electrode slurry. In this case, the negative electrode active material, CMC, and SBR were mixed so as to achieve a mass ratio of 98.6:0.7:0.4. The negative electrode slurry thus produced was subsequently coated onto both surfaces of a copper foil (thickness: 10 μm) as the negative electrode substrate, and then dried to remove the water used as the solvent during slurry production and form a negative electrode active material mixture layer. The negative electrode active material layer was thereafter calendered to a predetermined packing density (1.10 g/cc) using calendar rolls, and a negative electrode lead was furthermore attached to the exposed portion of the negative electrode substrate to thereby produce a negative electrode plate.

The packing density of the positive electrode plate and the negative electrode plate was calculated in the following manner. First, electrode plates were cut out to 10 cm², and the mass A (g) of the 10 cm² electrode plates and the thickness of the electrode plates C (cm) were measured. Next, the mass B (g) of the 10 cm² substrates and the thickness of the substrates D (cm) were measured. The packing density was calculated using the following formula.

Packing density=(A−B)/((C−D)×10 cm²)

### [Preparation of Nonaqueous Electrolyte]

Lithium hexafluorophosphate (LiPF₆) was dissolved as a solute in a ratio of 1 mol/L in a mixed solvent obtained by mixing ethylene carbonate (EC), which is a cyclic carbonate, ethylmethyl carbonate (EMC), which is a chain carbonate, and dimethyl carbonate (DMC) to achieve a volume ratio of 3:3:4. Vinylene carbonate (VC) was added in the amount of 1 mass % to the above-obtained solution to prepare a nonaqueous electrolyte.

### [Production of Nonaqueous Electrolyte Secondary Battery]

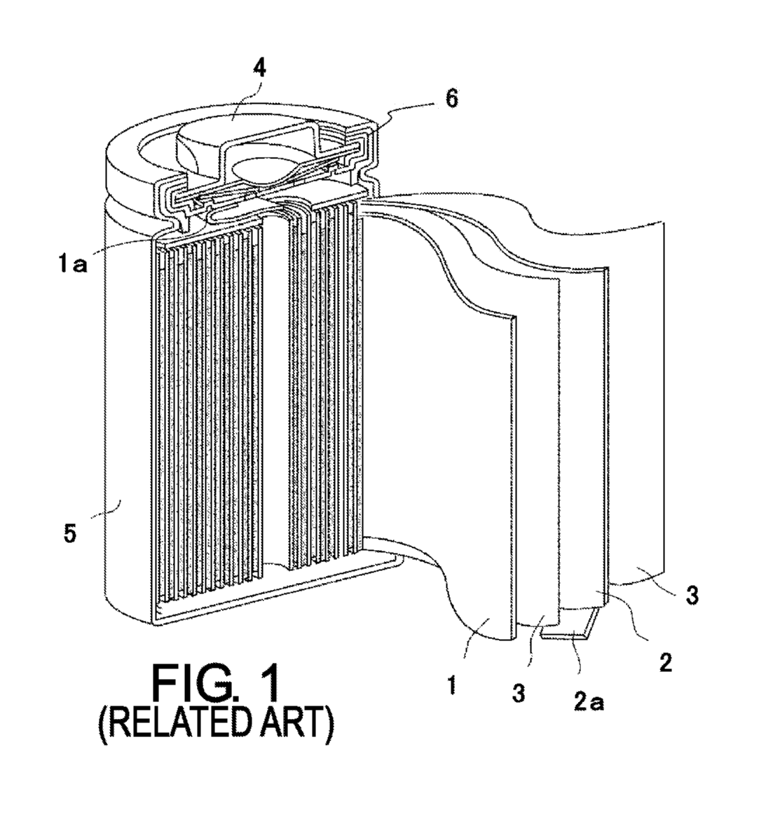

A 18650-type cylindrical nonaqueous electrolyte secondary battery was produced using the positive electrode plates, negative electrode plates, and nonaqueous electrolyte produced in the manner described above. The nonaqueous electrolyte secondary battery (rated capacity: 700 mAh) was used as battery A1. This cylindrical nonaqueous electrolyte secondary battery was obtained by accommodating a wound electrode assembly in which positive electrode plates 1 and negative electrode plates 2 are wound via a separator 3, together with the nonaqueous electrolyte inside a cylindrical outer covering can 5 having a bottom, as shown in FIG. 1. The opening of the outer covering can 5 was sealed by a seal 4, insulation packing 6 was interposed between the outer covering can 5 and the seal 4 to insulate the outer covering can 5 and the seal 4. The positive electrode lead 1a connected to the positive electrode plate 1 is connected to the seal 4, and the seal 4 serves as a positive electrode terminal. A negative electrode lead 2a connected to the negative electrode plate 2 is connected to the outer covering can 5, and the outer covering can 5 serves are the negative electrode terminal.

### Example 2

Li₂CO₃, (Ni_{0.50}Co_{0.20}Mn_{0.30})₃O₄, and ZrO₂ were mixed together so that the molar ratio of Li, (Ni_{0.50}CO_{0.20}Mn_{0.30}), and Zr was 1.15:1:0.005. Next, this mixture was baked for 20 hours at 820° C. in an air atmosphere, and a lithium-transition metal complex oxide (Li_{1.15}Ni_{0.50}Co_{0.20}Mn_{0.30}O₂ in which Zr is present near the particle surface) containing 0.5 mol % of Zr with respect to the total amount of Ni, Co, and Mn was obtained and used as the positive electrode active material. A nonaqueous electrolyte secondary battery (rated capacity: 700 mAh) was otherwise produced in the same manner as example 1 to obtain battery A2. The average crystallite size of the produced lithium-transition metal complex oxide was 679 Å, and the bulk density was 2.09 g/cc.

### Comparative Example 1

Li₂CO₃, (Ni_{0.50}Co_{0.20}Mn_{0.30})₃O₄, and ZrO₂ were mixed together so that the molar ratio of Li, (Ni_{0.50}CO_{0.20}Mn_{0.30}), and Zr was 1.15:1:0.005. Next, this mixture was baked for 20 hours at 880° C. in an air atmosphere, and a lithium-transition metal complex oxide (Li_{1.15}Ni_{0.50}Co_{0.20}Mn_{0.30}O₂ in which Zr is present near the particle surface) containing 0.5 mol % of Zr with respect to the total amount of Ni, Co, and Mn was obtained and used as the positive electrode active material. A nonaqueous electrolyte secondary battery (rated capacity: 700 mAh) was otherwise produced in the same manner as example 1 to obtain battery X1. The average crystallite size of the produced lithium-transition metal complex oxide was 1348 Å, and the bulk density was 2.10 g/cc.

### Comparative Example 2

Li₂CO₃ and (Ni_{0.50}CO_{0.20}Mn_{0.30})₃O₄ were mixed together so that the molar ratio of Li and (Ni_{0.50}Co_{0.20}Mn_{0.30}) was 1.15:1. This mixture was baked for 20 hours at 840° C. in an air atmosphere, and a lithium-transition metal complex oxide represented by Li_{1.15}Ni_{0.50}Co_{0.20}Mn_{0.30}O₂ was obtained and used as the positive electrode active material. A nonaqueous electrolyte secondary battery (rated capacity: 700 mAh) was otherwise produced in the same manner as example 1 to obtain battery X2. The average crystallite size of the positive electrode active material was 1001 Å, and the bulk density was 2.09 g/cc.

### Comparative Example 3

Li₂CO₃, (Ni_{0.35}Co_{0.35}Mn_{0.30})₃O₄, and ZrO₂ were mixed together so that the molar ratio of Li, (Ni_{0.35}CO_{0.35}Mn_{0.30}), and Zr was 1.19:1:0.005. Next, this mixture was baked for 20 hours at 870° C. in an air atmosphere, and a lithium-transition metal complex oxide (Li_{1.19}Ni_{0.35}Co_{0.35}Mn_{0.30}O₂ in which Zr is present near the particle surface) containing 0.5 mol % of Zr with respect to the total amount of Ni, Co, and Mn was obtained and used as the positive electrode active material. A nonaqueous electrolyte secondary battery (rated capacity: 700 mAh) was otherwise produced in the same manner as example 1 to obtain battery X3. The average crystallite size of the produced positive electrode active material was 1336 Å, and the bulk density was 2.31 g/cc.

The batteries A1, A2, and X1 to X3 produced in the manner described above were measured for discharge capacity and normal temperature IV, and were subjected to a 10 A cycling test at 60° C.

### [Measurement of Discharge Capacity]

Constant-current charging at a charge current of 1 C was carried out up to 4.1 V, and constant-voltage charging at 4.1 V was then carried out for two hours, after which constant-current discharging was carried out at a discharge current of 1 C up to 2.5 V. The discharge capacity at this time was used as the initial discharge capacity.

[10 A cycling test at 60° C.]

A discharge cycling test was carried out by allowing a 10 A electric current to flow in a voltage range of 2.5 V to 4.1 V in a 60° C. environment. After 500 cycles, the discharge capacity was calculated using the same method as the discharge capacity measurement described above, and the result was used as the discharge capacity after 500 cycles.

The capacity retention ratio was calculated with the following formula using the above-described initial discharge capacity and discharge capacity after 500 cycles.

Capacity retention ratio (%)=discharge capacity after 500 cycles/initial discharge capacity

### [Normal Temperature IV Measurement]

With the batteries charged to a SOC of 50% at normal temperature (25° C.), discharging was carried out for 10 seconds at an electric current of 0.1 to 35 A. Battery voltages were measured, the electric current values and battery voltages were plotted to obtain the output during discharge, and the output density was calculated by dividing by the battery volume.

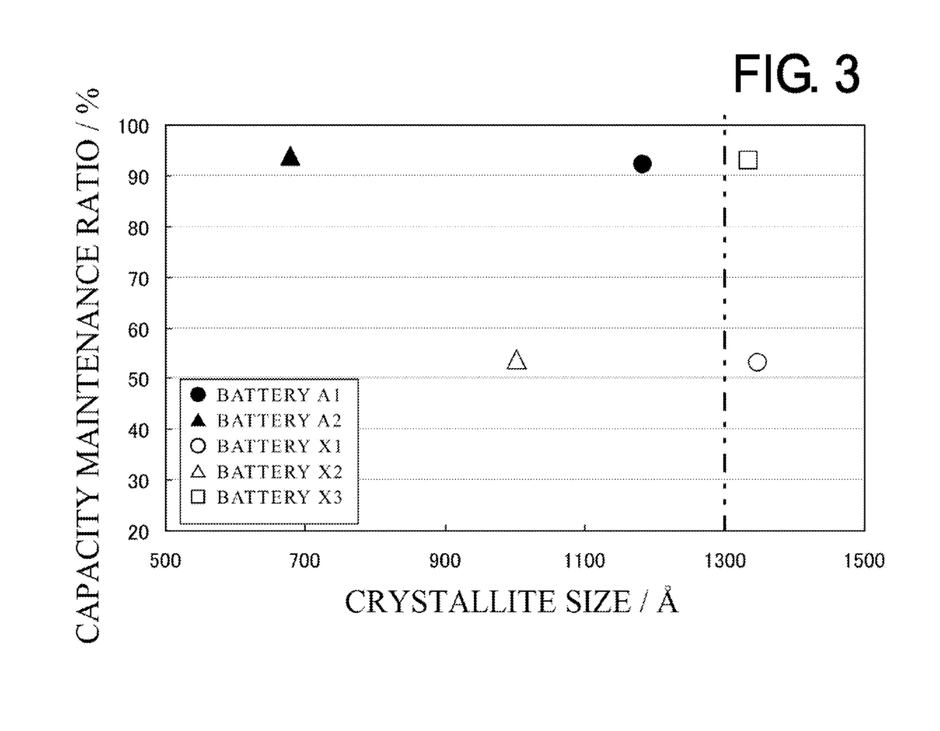

The capacity retention ratio and output density of each battery is shown in Table 1. The relationship between the average crystallite size and the capacity retention ratio for each battery is shown in FIG. 3.

TABLE 1

| | | Average | Output | Capacity |
|---|---|---|---|---|
| | Zr addition | crystallite | density | retention ratio |
| | (mol %) | size (Å) | (W/L) | (%) |
| Battery A1 | 0.5 | 1183 | 6003 | 92 |
| Battery A2 | 0.5 | 679 | 5936 | 94 |
| Battery X1 | 0.5 | 1348 | 6118 | 53 |
| Battery X2 | None | 1001 | 6051 | 54 |
| Battery X3 | 0.5 | 1336 | 6021 | 93 |

It is apparent from Table 1 and FIG. 3 that the capacity retention ratios of the battery X1, in which the average crystallite size of the lithium-transition metal complex oxide was 1348 Å, and the battery X2, which did not contain Zr in the lithium-transition metal complex oxide, were very low values at 53% and 54%, respectively. In contrast, the capacity retention ratios of the batteries A1 and A2, which contained Zr and had average crystallite sizes of 1183 Å and 679 Å, respectively, were high values at 92% and 94%, respectively. Battery X3, in which the Ni content in the lithium-transition metal complex oxide was relatively low at 0.35 mol % with respect to the total amount of Ni, Co, and Mn, had an average crystallite size of 1336 Å, yet the value of the capacity retention ratio was high at 93%. Therefore, it is apparent that a reduction in capacity due to high-rate charge and discharge cycling does not occur when the Ni content in the lithium-transition metal complex oxide is low.

### Experiment 2

### Example 3

### Production of a Positive Electrode Plate

Li₂CO₃, (Ni_{0.465}Co_{0.275}Mn_{0.26})₃O₄, and ZrO₂ were mixed together so that the molar ratio of Li, (Ni_{0.465}Co_{0.275}Mn_{0.26}), and Zr was 1.14:1:0.005. Next, this mixture was baked for 20 hours at 850° C. in an air atmosphere, and a lithium-transition metal complex oxide (Li_{1.14}Ni_{0.465}Co_{0.275}Mn_{0.260}O₂ in which Zr is present near the particle surface) containing 0.5 mol % of Zr with respect to the total amount of Ni, Co, and Mn was obtained and used as the positive electrode active material. The average crystallite size of the lithium-transition metal complex oxide obtained in this manner was 1103 Å, and the bulk density was 2.26 g/cc. The positive electrode active material produced using the method described above, carbon black as an electroconductive agent, and a solution of polyvinylidene fluoride (PVdF) as a binder dissolved in N-methyl-2-pyrrolidone (NMP) were kneaded together so that the mass ratio of positive electrode active material, carbon black, and polyvinylidene fluoride PVdF was 92:5:3 to produce a positive electrode slurry. The bulk density of the carbon black used in this case was 0.16 g/cc. The produced positive electrode slurry was coated on both surfaces of an aluminum alloy foil (thickness: 15 μm) as the positive electrode substrate, and then allowed to dry to remove the NMP used as the solvent during slurry production and form a positive electrode active material mixture layer. The positive electrode active material layer was thereafter calendered to a predetermined packing density (2.5 g/cc) using calendar rolls, and cut to predetermined dimensions to produce a positive electrode plate.

### [Production of a Negative Electrode Plate]

A matrix of spheroidized natural graphite was impregnated and coated with a mixture of pitch and carbon black. In this case, the natural graphite, pitch, and carbon black were mixed so as to achieve a mass ratio of 100:5:5. Next, the mixture was baked at 900 to 1500° C., the baked product was pulverized, and a graphite surface-coated with an amorphous carbon was obtained and used as the negative electrode active material. The negative electrode active material obtained in the manner described above, flaked graphite as an electroconductive agent, carboxymethyl cellulose (CMC) as a viscosity improver, and styrene-butadiene rubber (SBR) as a viscosity improver were kneaded together with water to produce a negative electrode slurry. In this case, the negative electrode active material to which the flaked graphite had been added, carboxymethyl cellulose (CMC), and styrene-butadiene rubber (SBR) were mixed so as to achieve a mass ratio of 98.7 (the flaked graphite was 2.0 mass % with respect to the total amount of the flaked graphite-added negative electrode active material):0.7:0.6. The negative electrode slurry thus produced was subsequently coated onto both surfaces of a copper foil (thickness: 10 μm) as the negative electrode substrate, and then dried to remove the water used as the solvent during slurry production and form a negative electrode active material mixture layer. The negative electrode active material layer was thereafter calendered to a predetermined packing density (1.3 g/cc) using calendar rolls.

### [Preparation of Nonaqueous Electrolyte]

Lithium hexafluorophosphate (LiPF₆) was dissolved as a solute in a ratio of 1 mol/L in a mixed solvent obtained by mixing ethylene carbonate (EC), which is a cyclic carbonate, ethylmethyl carbonate (EMC), which is a chain carbonate, and dimethyl carbonate (DMC) to achieve a volume ratio of 3:3:4. Vinylene carbonate (VC) was added in the amount of 0.3 mass % to the above-obtained solution to prepare a nonaqueous electrolyte.

### [Production of Nonaqueous Electrolyte Secondary Battery]

A cylindrical group of electrodes was produced by winding the positive electrode plates and negative electrode plates produced in the manner described above, via separators composed of a polyethylene porous membrane. The cylindrical group of electrodes was flattened to form a flat electrode group 11. A strip-shaped exposed-substrate part, on which an active material layer was not formed, was formed on both surfaces along the lengthwise direction at one end of the positive electrode plate and the negative electrode plate, the exposed positive electrode substrate part 7 was formed at one end in the axial direction of winding on the spiral-shaped flat electrode group 11, and an exposed negative electrode substrate part 8 was formed at the other end in the axial direction of winding. Next, one end of a positive electrode terminal 14 is inserted into a through-hole provided in a seal 13, and is secured to the seal 13 connected to a positive electrode assembly 9. One end of a negative electrode terminal 15 is inserted into a through-hole provided in the seal 13 and secured to the seal 13 in a state connected to a negative electrode assembly 10. In this case, an insulating member 16 is interposed between the seal 13, and the positive electrode terminal 14 and positive electrode assembly 9, to form an insulated state between the seal 13, and the positive electrode terminal 14 and positive electrode assembly 9. An insulating member 17 is interposed between the seal 13, and a negative electrode terminal 15 and a negative electrode assembly 10, to form an insulated state between the seal 13, and the negative electrode terminal 15 and negative electrode assembly 10. The positive electrode assembly 9 was connected to the exposed positive electrode substrate part 7 by resistance welding, and the negative electrode assembly 10 was connected to the exposed negative electrode substrate part 8 by resistance welding. The external periphery of the flat electrode group 11 was covered by an insulating sheet (not shown), then inserted into an outer covering can 12, and the opening part of the outer covering can 12 and the fitting part of the seal 13 were connected by laser welding to seal the outer covering can 12. A predetermined amount of the nonaqueous electrolyte prepared using the method described above was injection via an electrolyte injection port (not shown) provided in the seal 13. The electrolyte injection port was hermetically sealed by a seal material (not shown) to thereby produce a quadrangular nonaqueous electrolyte secondary battery (rated capacity: 25 Ah) and obtain a battery A3.

### Example 4

Li₂CO₃, (Ni_{0.465}Co_{0.275}Mn_{0.26})₃O₄, and ZrO₂ were mixed together so that the molar ratio of Li, (Ni_{0.465}Co_{0.275}Mn_{0.26}), and Zr was 1.14:1:0.005. Next, this mixture was baked for 20 hours at 870° C. in an air atmosphere, and a lithium-transition metal complex oxide (Li_{1.14}Ni_{0.465}Co_{0.275}Mn_{0.26}O₂ in which Zr is present near the particle surface) containing 0.5 mol % of Zr with respect to the total amount of Ni, Co, and Mn was obtained and used as the positive electrode active material. A nonaqueous electrolyte secondary battery (rated capacity: 25 Ah) was otherwise produced in the same manner as example 3 to obtain battery A4. The average crystallite size of the produced lithium-transition metal complex oxide was 1278 Å, and the bulk density was 2.53 g/cc.

### Example 5

Li₂CO₃, (Ni_{0.465}Co_{0.275}Mn_{0.26})₃O₄, and ZrO₂ were mixed together so that the molar ratio of Li, (Ni_{0.465}Co_{0.275}Mn_{0.26}), and Zr was 1.11:1:0.005. Next, this mixture was baked for 20 hours at 870° C. in an air atmosphere, and a lithium-transition metal complex oxide (Li_{1.11}Ni_{0.465}Co_{0.275}Mn_{0.26}O₂ in which Zr is present near the particle surface) containing 0.5 mol % of Zr with respect to the total amount of Ni, Co, and Mn was obtained and used as the positive electrode active material. A nonaqueous electrolyte secondary battery (rated capacity: 25 Ah) was otherwise produced in the same manner as example 3 to obtain battery A5. The average crystallite size of the produced lithium-transition metal complex oxide was 713 Å, and the bulk density was 2.70 g/cc.

### Comparative Example 4

Li₂CO₃, (Ni_{0.465}Co_{0.275}Mn_{0.26})₃O₄, and ZrO₂ were mixed together so that the molar ratio of Li, (Ni_{0.465}Co_{0.275}Mn_{0.26}), and Zr was 1.11:1:0.005. Next, this mixture was baked for 20 hours at 920° C. in an air atmosphere, and a lithium-transition metal complex oxide (Li_{1.11}Ni_{0.465}Co_{0.275}Mn_{0.260}O₂ in which Zr is present near the particle surface) containing 0.5 mol % of Zr with respect to the total amount of Ni, Co, and Mn was obtained and used as the positive electrode active material. A nonaqueous electrolyte secondary battery (rated capacity: 25 Ah) was otherwise produced in the same manner as example 3 to obtain battery X4. The average crystallite size of the produced lithium-transition metal complex oxide was 1430 Å, and the bulk density was 2.44 g/cc.

The batteries A3 to A5, and battery X4 produced in the manner described above were measured for discharge capacity and normal temperature IV, and were subjected to a 2 C cycling test at 60° C.

### [Measurement of Discharge Capacity]

Constant-current charging at a charge current of 1 C was carried out up to 4.1 V, and constant-voltage charging at 4.1 V was then carried out for two hours, after which constant-current discharging was carried out at a discharge current of ⅓ C up to 3.0 V, and constant-voltage discharge was carried out for 5 hours at 3.0 V. The discharge capacity at this time was used as the initial discharge capacity.

[2 C cycling test at 60° C.]

A discharge cycling test was carried out by allowing a 2 C electric current to flow in a voltage range of 3.0 V to 4.1 V in a 60° C. environment. After 200 cycles, the discharge capacity was calculated using the same method as the discharge capacity measurement described above, and the result was used as the discharge capacity after 200 cycles.

The capacity retention ratio was calculated with the following formula using the above-described initial discharge capacity and discharge capacity after 200 cycles. Capacity retention ratio (%)=discharge capacity after 200 cycles/initial discharge capacity

### [Normal Temperature IV Measurement]

With the batteries charged to a SOC of 50% at normal temperature (25° C.), discharging was carried out for 10 seconds at electric currents of 1.6 C, 3.2 C, 4.8 C, 6.4 C, 8.0 C, and 9.6 C. Battery voltages were measured, the electric current values and battery voltages were plotted to obtain the output during discharge, and the output density was calculated by dividing by the battery volume.

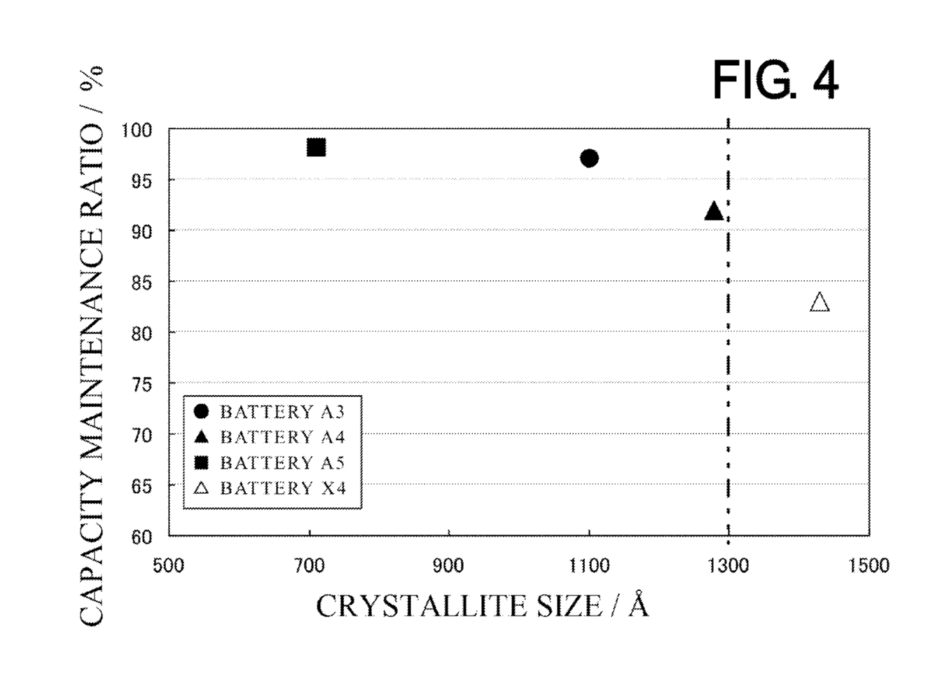

The capacity retention ratio and output density of each battery is shown in Table 2. The value of the capacity retention ratio with respect to the average crystallite size for each battery is shown in FIG. 4.

TABLE 2

| | Average | Output | Capacity |
|---|---|---|---|
| | crystallite | density | retention ratio |
| | size (Å) | (W/L) | (%) |
| Battery A3 | 1103 | 3777 | 97 |
| Battery A4 | 1278 | 3651 | 92 |
| Battery A5 | 713 | 3648 | 98 |
| Battery X4 | 1430 | 3533 | 83 |

It is apparent from Table 2 and FIG. 4 that the capacity retention ratio of the battery X4, in which the average crystallite size of the lithium-transition metal complex oxide was 1430 Å, was a low value at 83%. In contrast, the capacity retention ratios of the batteries A3, A4, and A5 which contained Zr and had average crystallite sizes of 1103 Å, 1278 Å, and 713 Å, respectively, were high values at 97%, 92%, and 98%, respectively.

### Experiment 3

### Reference Example 1

Using the lithium-transition metal complex oxide produced in example 1 of experiment 1 as the positive electrode active material, the positive electrode active material, a vapor grown carbon fiber (VGCF) as the electroconductive agent, and a solution of polyvinylidene fluoride (PVdF) as a binder dissolved in a N-methyl-2-pyrrolidone (NMP) solution were prepared so that the mass ratio of positive electrode active material, the electroconductive agent, and the binder was 92:5:3, and these were kneaded together to produce a positive electrode slurry. This positive electrode slurry was coated onto both surfaces of a positive electrode substrate composed of aluminum foil, the resulting assembly was dried and calendered using calendar rolls, and collector tabs made of aluminum were attached to the positive electrode substrate to produce a positive electrode plate.

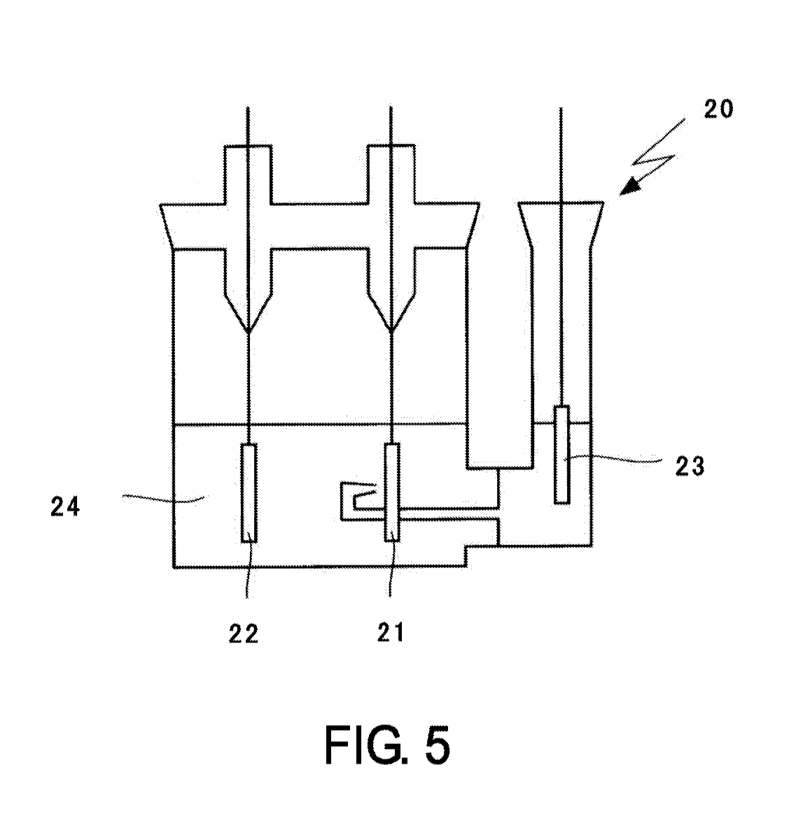

The positive electrode plate produced in the manner described above was used as the active electrode 21, metallic lithium was used as a reference electrode 23 and a counter electrode 22, which is the negative electrode, as shown in FIG. 5. LiPF was dissolved in a ratio of 1 mol/L in a mixed solvent obtained by mixing ethylene carbonate (EC), methylethyl carbonate (MEC), and dimethyl carbonate (DMC) to achieve a volume ratio of 3:3:4, and this was used as a nonaqueous electrolyte 24. Vinylene carbonate 6 (VC) was furthermore dissolved in the amount of 1 mass % to produce a three-electrode test cell 20, which was used as test cell Z1.

### Reference Example 2

Other than using the lithium-transition metal complex oxide produced in example 2 of experiment 1 as the positive electrode active material, a three-electrode test cell 20 was produced in the same manner as reference example 1, and this was used as test cell Z2.

### Reference Example 3

Other than using the lithium-transition metal complex oxide produced in example 1 of experiment 1 as the positive electrode active material, a three-electrode test cell 20 was produced in the same manner as reference example 1, and this was used as test cell Z3.

### Reference Example 4

Other than using the lithium-transition metal complex oxide produced in comparative example 3 of experiment 1 as the positive electrode active material, a three-electrode test cell 20 was produced in the same manner as reference example 1, and this was used as test cell Z4.

Next, each of the test cells Z1 to Z4 fabricated in the manner described above was subjected to constant-current charging at an electric current density of 0.2 mA/cm² up to 4.3 V (vs. Li/Li⁺) under normal temperature conditions of 25° C., and constant-voltage charging at a constant voltage of 4.3 V (vs. Li/Li⁺) was then carried out until the electric current density reached 0.04 mA/cm², after which constant-current discharging was carried out at an electric current density of 0.2 mA/cm² up to 2.5 V (vs. Li/Li⁺). The discharge capacity was obtained and the discharge capacity per unit of weight of the positive electrode active material in the positive electrode was calculated. The results are shown in Table 3 together with the molar ratio of Ni:Co:Mn in the positive electrode active material used in the test cells.

TABLE 3

| | | Discharge capacity |
|---|---|---|
| | Ni:Co:Mn | (mAh/g) |
| Test cell Z1 | 0.50:0.20:0.30 | 167 |
| Test cell Z2 | 0.465:0.275:0.26 | 172 |
| Test cell Z3 | 0.50:0.20:0.30 | 169 |
| Test cell Z4 | 0.35:0.35:0.30 | 152 |

It is apparent from Table 3 that the capacity per unit mass was low for the test cell Z4 in which the ratio of the Ni content in the lithium-transition metal complex oxide was low, in comparison with the test cells Z1 to Z3 in which the ratio of the Ni content in the lithium-transition metal complex oxide was high. Therefore, it is apparent that a lithium-transition metal complex oxide having a low ratio of Ni content is unsuitable as a positive electrode active material used in a battery which requires high capacity.

In view of the above, it is apparent that including Zr in the lithium-transition metal complex oxide and making the average crystallite size to be 1300 Å or less by using as the positive electrode active material a lithium-transition metal complex oxide having a layered structure represent by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn), whereby a high-capacity nonaqueous electrolyte secondary battery having excellent high-rate charge/discharge cycling characteristics can be obtained.

What is claimed is:

1. A nonaqueous electrolyte secondary battery comprising:
a positive electrode containing a lithium-transition metal complex oxide having a layered structure as a positive electrode active material;
a negative electrode containing a negative electrode active material capable of occluding and releasing lithium ions; and
a nonaqueous electrolyte, wherein
the lithium-transition metal complex oxide is represented by the general formula Li₁₊ₐNiₓCo_{y}Mn_{z}M_{b}O₂ (where 0≦a≦0.15, 0≦b, 0.4≦x≦1.0, y<x, z<x, x+y+z+b=1, and M is one or more elements selected from other than Li, Ni, Co, and Mn), contains Zr, and has an average crystallite size of 1300 Å or less as calculated using the Halder-Wagner method from an integral breadth calculated using the Pawley method.

2. The nonaqueous electrolyte secondary battery according to claim 1, wherein the lithium-transition metal complex oxide is represented by the general formula Li₁₊ₐNiₓCo_{y}Mn_{z}M_{b}O₂ (where 0≦a≦0.15, 0≦b≦0.05, 0.4≦x≦0.8, 0<y≦0.35, 0<z≦0.30, x+y+z+b=1, and M is one or more elements selected from other than Li, Ni, Co, and Mn).

3. The nonaqueous electrolyte secondary battery according to claim 1, wherein the element M is one or more elements selected from the group consisting of Al, Sr, Y, Zr, Ta, Mg, Ti, Zn, B, Ca, Cr, Si, Ga, Sn, P, V, Sb, Nb, Mo, W, and Fe.

4. The nonaqueous electrolyte secondary battery according to claim 1, wherein the Zr content of the lithium-transition metal complex oxide is 0.1 to 3.0 mol % with respect to the total amount of Ni, Co, and Mn.

5. The nonaqueous electrolyte secondary battery according to claim 1, wherein the lithium-transition metal complex oxide is obtained by mixing and baking a lithium-transition metal complex oxide precursor and a Zr compound.

6. The nonaqueous electrolyte secondary battery according to claim 1, wherein the lithium-transition metal complex oxide is an aggregation of primary particles that form secondary particles.

7. The nonaqueous electrolyte secondary battery according to claim 1, wherein the positive electrode has a positive electrode active material layer containing the lithium-transition metal complex oxide and a binder formed on the surface of a positive electrode core, the positive electrode active material layer contains a carbon material having a lower bulk density than the lithium-transition metal complex oxide, and the carbon material is contained in an amount of 3 mass % or more with respect to the positive electrode active material.

8. The nonaqueous electrolyte secondary battery according to claim 7, wherein the bulk density of the carbon material is 0.01 to 0.50 g/cc.

9. The nonaqueous electrolyte secondary battery according to claim 7, wherein the packing density of the positive electrode active material layer is 2.0 to 3.5 g/cc.

10. The nonaqueous electrolyte secondary battery according to claim 9, wherein the packing density of the positive electrode active material layer is 2.0 to 3.0 g/cc.
